(19) United States
(12) Patent Application Publication
(10) Pub. No.: US 2010/0175834 A1
(43) Pub. Date: Jul. 15, 2010

(54) WAFER SPLITTING LAMINATE MECHANISM

(76) Inventor: Shin-Kan LIU, Taichung City (TW)

Correspondence Address: Muncy, Geissler, Olds & Lowe, PLLC, 4000 Legato Road, Suite 310, FAIRFAX, VA, 22033, US

(21) Appl. No.: 12/352,822

(22) Filed: Jan. 13, 2009

(51) Int. Cl. B32B 38/10

(52) U.S. Cl. 156/350

(57) ABSTRACT

A wafer splitting laminate mechanism mounted onto a wafer spitting machine to anchor a wafer includes a cantilever bar, an activating mechanism and a suppressing element. The activating mechanism is fixedly located on the wafer splitting machine to connect and drive the cantilever bar to move. The suppressing element is located at one end of the cantilever bar. The wafer is held by a fixed clip and positioned on a work station of the wafer splitting machine. During preparing the wafer splitting process, the activation mechanism drives the cantilever bar to move and suppress the wafer before the splitting process is performed. Thus warping of the wafer can be reduced during the splitting process.

### FIELD OF THE INVENTION

The present invention relates to a wafer processing apparatus and particularly to a wafer splitting machine to split wafers.

### BACKGROUND OF THE INVENTION

A conventional wafer splitting machine, referring to FIGS. 1 and 2, aims to split a wafer 1 into individual chips for downstream packaging processes. Before the wafer 1 is split, transverse and longitudinal pre-cutting lines 2 are formed thereon by laser cutting; then the wafer 1 is bonded by a tape 3 for protection; finally it is transported through a fixed clip 4 to the wafer splitting machine to perform splitting process.

The wafer splitting machine includes a work station 5, a cutter 6, a splitting deck 7 and an image capturing system 8. The work station 5 holds the fixed clip 4 and can be moved horizontally and turned. The cutter 6 and the splitting deck 7 are located respectively on an upper side and a lower side of the wafer 1. The wafer 1 is pressed to the splitting deck 7 and punched by the cutter 6 during the splitting process. The image capturing system 8 captures the image of the wafer 1 and gets the position of the wafer 1 through the pre-cutting lines 2.

The wafer 1 can be positioned through the movement of the work station 5 and the detection of the image capturing system 8. After positioned, through the up and down movements of the cutter 6 and quantitative movements of the work station 5, the splitting process can be performed consecutively on the pre-cutting lines 2. The image capturing system 8 monitors the position of the wafer 1 during the consecutive splitting process to detect whether deviations occur. Depending on the deviations, repositioning could be carried out. After all the transverse and longitudinal pre-cutting lines 2 have been split, the spitting process is finished.

However, during the splitting process of the conventional wafer splitting machine, warping often occurs to the wafer 1. When the splitting process takes place repeatedly, warping could become very serious and result in focusing error of the image capturing system 8. Then the wafer 1 has to be suppressed manually to allow the image of the wafer 1 to be recaptured by the image capturing system 8 for positioning. This is a risky operation and can easily damage the wafer 1. Trying to boost production yield also is difficult, and defects increase. Hence there are still rooms for improvement.

### SUMMARY OF THE INVENTION

Therefore, the primary object of the present invention is to provide a wafer splitting laminate mechanism to reduce warping of wafers during splitting process.

The wafer splitting laminate mechanism according to the invention is mounted onto a wafer splitting machine to suppress a wafer. The wafer is held by a fixed clip and positioned on a work station of the wafer splitting machine. The wafer splitting laminate mechanism includes an activating mechanism, a cantilever bar and a suppressing element. The activating mechanism is fixedly mounted onto the wafer splitting machine. The cantilever bar is connected to and driven by the activating mechanism and is movable. The suppressing element is located at one end of the cantilever bar, and forms two conditions of suppressing the wafer and non-suppressing the wafer according to movement positions of the cantilever bar.

Thus during the wafer splitting process, the wafer can be suppressed by the suppressing element to reduce warping thereof. Therefore, quality improves and repositioning can be reduced. And consecutive splitting can be accomplished more frequently. Such a mechanism also can facilitate automation to accomplish continuous operation with automatic image capturing and automatic correction of the splitting position. As a result, production yield increases and defects can be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fragmentary schematic view of a conventional wafer splitting apparatus.

FIG. 2 is a schematic view of a conventional wafer pending to be split.

FIG. 3 is a front view of the wafer splitting laminate mechanism of the invention.

FIG. 4 is a schematic view of the wafer splitting laminate mechanism of the invention in an operating condition.

FIG. 5 is a top view of the wafer splitting laminate mechanism of the invention.

FIG. 6 is a front view of the invention with a splitting wafer mounted.

FIG. 7 is a top view of the invention with a splitting wafer mounted.

FIG. 8A is a schematic view of the invention in an operating condition for splitting a wafer.

FIG. 8B is a schematic view of the invention in another operating condition for splitting a wafer.

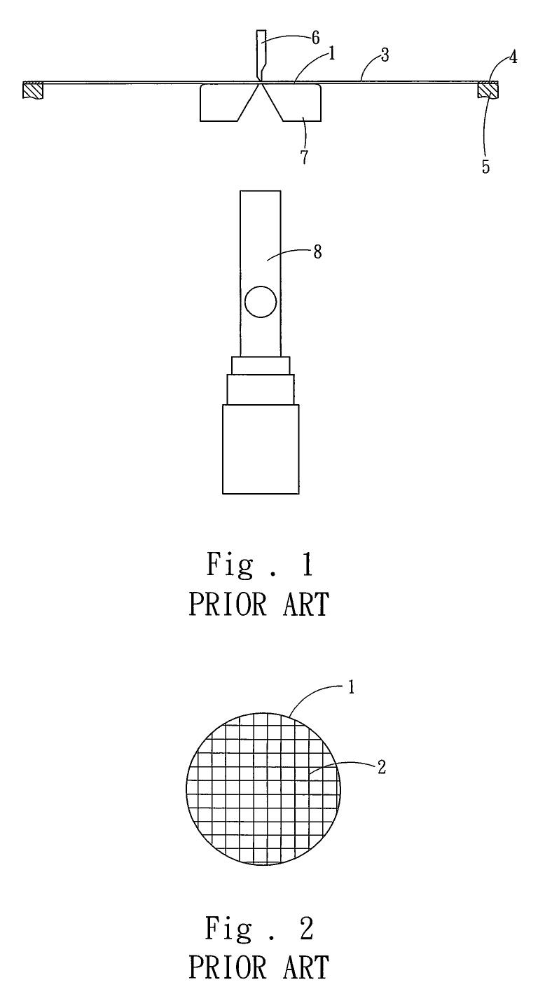

### DETAILED DESCRIPTION OF THE PREFERRED EMBODIMENT

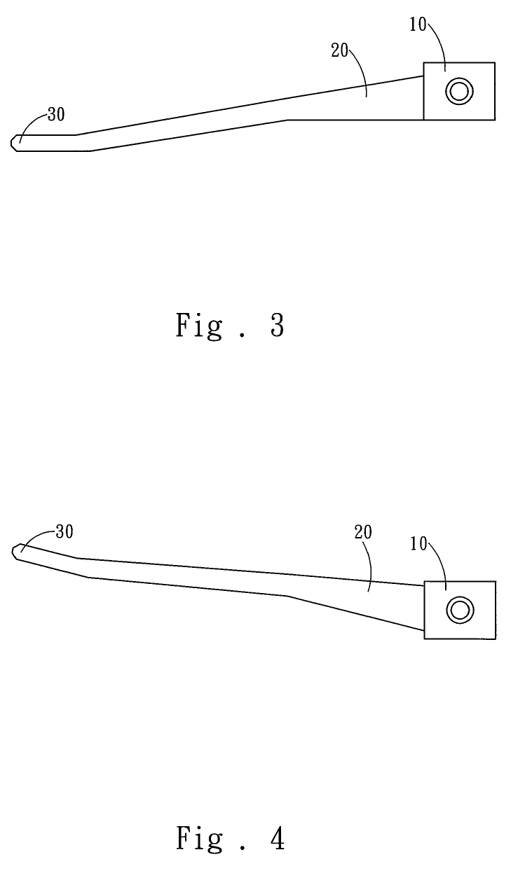

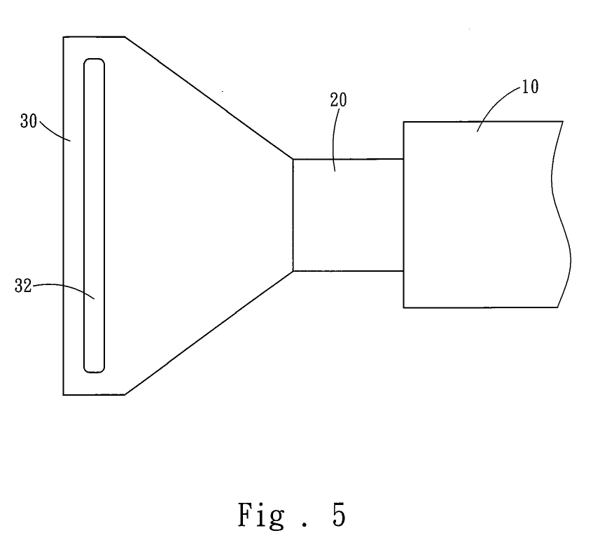

Please refer to FIGS. 3, 4 and 5, the wafer splitting laminate mechanism according to the invention includes an activating mechanism 10, a cantilever bar 20 and a suppressing element 30. The cantilever bar 20 is connected to and driven by the activating mechanism 10, and is movable. The activating mechanism 10 is turnable to drive the cantilever bar 20 to sway up and down. FIG. 4 shows the cantilever bar 20 being swayed upwards. The suppressing element 30 is located at one end of the cantilever bar 20, and may be connected therewith in an integrated manner. The suppressing element 30 also has an orifice 32.

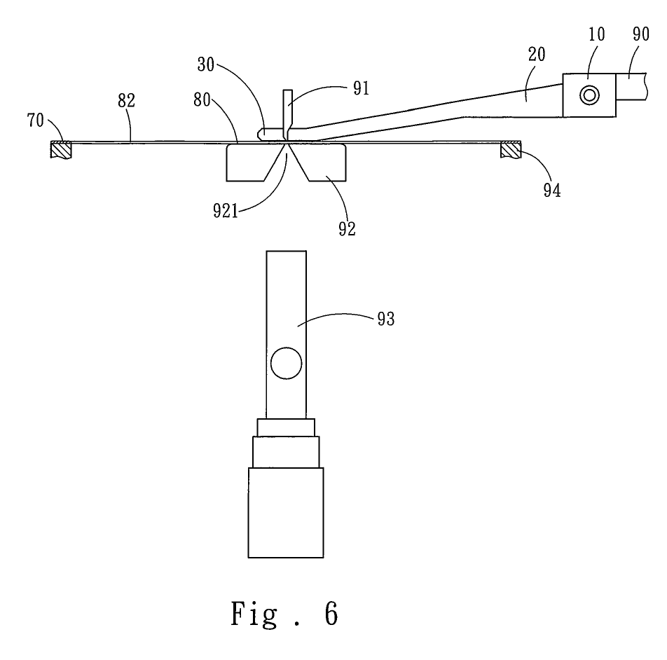

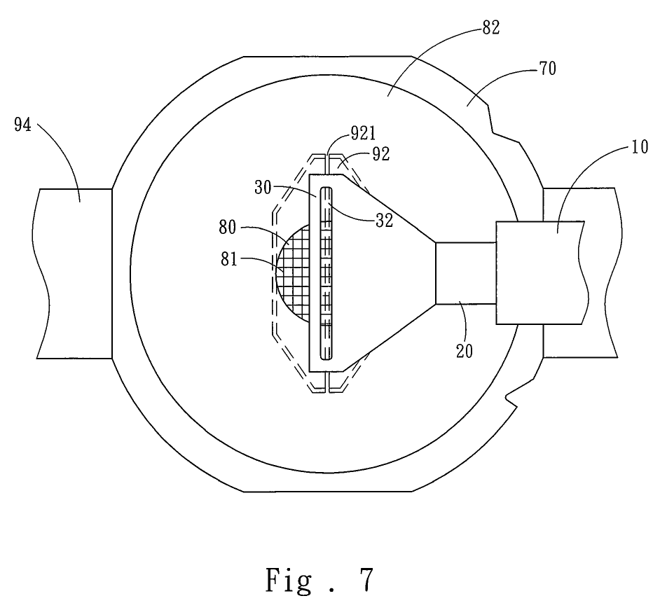

Referring to FIGS. 6 and 7, the invention is mounted onto a wafer splitting machine 90 which has a cutter 91, a splitting deck 92, an image capturing system 93 and a work station 94 to suppress a wafer 80. The wafer 80 has pre-cutting lines 81 formed through laser and is covered by a tape 82 for protection. The wafer 80 is held by a fixed clip 70 to be positioned on the work station 94. The work station 94 can carry and transport the wafer 80. The activating mechanism 10 is fixedly mounted onto the wafer splitting machine 90. The suppressing element 30 can be positioned in two conditions of suppressing the wafer 80 and non-suppressing the wafer 80 according to swaying up and down positions of the cantilever bar 20.

The suppressing element 30 and the splitting deck 92 are located respectively at two sides of the wafer 80. The splitting deck 92 is used to press to the wafer 80. The splitting deck 92 has a crevice 921. The crevice 921 and the cutter 92 are aligned with the orifice 32. The image capturing system 93 captures the image of the wafer 80 and determines the position of the wafer 80 according to the pre-cutting lines 81.

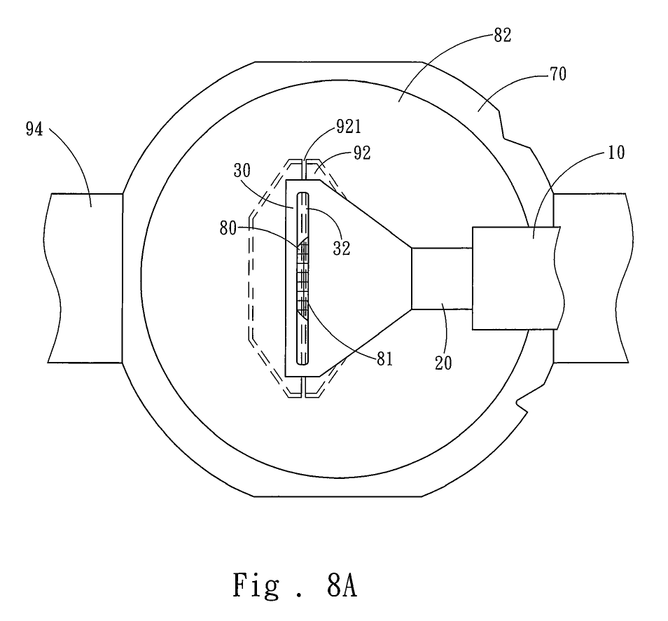

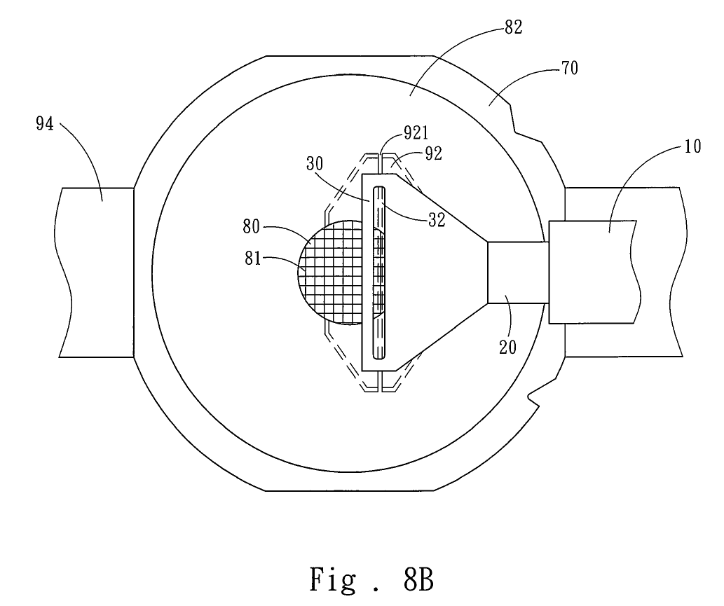

Referring to FIGS. 8A and 8B, when the wafer splitting laminate mechanism of the invention is in use, first, prepare the wafer 80 formed with the pre-cutting lines 81 and covered by the tape 82 to provide protection; next, hold the wafer 80 by the fixed clip 70 and position on the work station 94; move the work station 94 to allow the image capturing system 93 to align the pre-cutting line 81 at the edge of the wafer 80 (where splitting starts) with the crevice 921 of the splitting deck 92, meanwhile the suppressing element 30 is in the non-suppressing condition.

Then activate the activating mechanism 10 to move the suppressing element 30 at the suppressing condition to suppress the wafer 80; move the cutter 91 downwards to split the wafer 80 and return again, while the suppressing element 30 remains the suppressing condition to suppress the wafer 80; next, move the work station 94 transversely for a selected distance to allow the next pre-cutting line 81 (where splitting to be performed) to be aligned with the crevice 921; then move the cutter 91 downwards again to split the wafer 80 and return once more. Repeat the aforesaid operation until all the pre-cutting lines 81 are split. FIGS. 8A and 8B illustrate the splitting conditions with the work station 94 moved at different positions. To facilitate viewing, the cutter 91 is not shown in the drawings.

Then the work station 94 may be turned for 90 degrees to allow the wafer 80 to be split in another direction. During the consecutive splitting process, the image capturing system 93 is set on to continuously monitor whether the pre-cutting line 81 is aligned with the crevice 921 of the splitting deck 92. In the event that a deviation occurs, reposition of the work station 94 is performed.

As a conclusion, the invention provides the suppressing element 30 to suppress the wafer 80 during the splitting process, hence can reduce warping of the wafer 80 and greatly improve wafer quality. Consecutive splitting process can be performed more frequently. Focusing error of the image capturing system 93 caused by warping of the wafer 80 can be prevented. Repositioning frequency can be reduced. The invention also can facilitate automation to accomplish continuous operation with automatic image capturing and automatic correction of the splitting position. As a result, production yield increases and defects can be reduced.

What is claimed is:

1. A wafer splitting laminate mechanism mounted onto a wafer splitting machine to suppress a wafer held by a fixed clip positioned on a work station of the wafer splitting machine, comprising:
an activating mechanism fixedly located on the wafer splitting machine;
a cantilever bar connected to and driven by the activating mechanism and being movable; and
a suppressing element located at one end of the cantilever bar and forming two conditions of suppressing the wafer and non-suppressing the wafer according to movement positions of the cantilever bar.

2. The wafer splitting laminate mechanism of claim 1, wherein the activating mechanism is turnable to drive the cantilever bar to sway up and down to form two conditions of suppressing the wafer and non-suppressing the wafer.

3. The wafer splitting laminate mechanism of claim 1, wherein the wafer splitting machine includes a cutter, a splitting deck and an image capturing system; the suppressing element and the splitting deck being located at two sides of the wafer, the splitting deck is used to press the wafer, and has a crevice aligned with an orifice formed on the suppressing element, the image capturing system capturing images of the wafer.
